(19) United States
(12) Patent Application Publication
(10) Pub. No.: US 2004/0158433 A1
(43) Pub. Date: Aug. 12, 2004

(54) Process analysis systems with automatic liquid sample preparation and connection to process control systems

(75) Inventors: Andrea Wimschneider, Dusseldorf (DE); Martin Gerlach, Dormagen (DE); Burkhard Frisch, Leverkusen (DE); Michael Lahme, Dusseldorf (DE); Bernd Schmitz, Krefeld (DE); Karsten Sommer, Krefeld (DE)

Correspondence Address: Norris, McLaughlin & Marcus P.A., 30th Floor, 220 East 42nd Street, New York, NY, 10017, US

(73) Assignee: Bayer Aktiengesellschaft, Leverkusen (DE)

(21) Appl. No.: 10/755,754

(22) Filed: Jan. 12, 2004

(30) Foreign Application Priority Data
Jan. 16, 2003 (DE) 103 01 421.7

(51) Int. Cl. G06F 15/00

(52) U.S. Cl. 702/183

(57) ABSTRACT

An analysis system for a process, having:

means (100; 300) for taking a sample from the process,

sample preparation means (108; 302, 304, 306, 307, 308, 310, 312, 314, 316, 317, 318),

means (112) for analyzing the sample,

means (106, 116) for transmitting an analysis result (114) to a process control system (118, 120).

The invention relates to modular analysis systems for processes, for example chemical, physical, biochemical, biotechnological or other industrial processes, as well as to a corresponding connection to process control systems for controlling these processes, and to a computer program product.

### BACKGROUND OF THE INVENTION

It is known from the prior art that in order to monitor a process, for example the manufacture of a chemical product, samples are regularly taken from the process and then analyzed. To this end, in many cases it has previously been necessary for a laboratory assistant or technician to take a sample manually. In general, such a sample cannot be analyzed directly, but requires sample preparation before it is possible to carry out the actual analysis, for example using a chromatograph, a mass-spectrometry detector or another type of analyzer. In this case, for example, gas chromatographs or high-performance liquid chromatographs (HPLC) may be used as chromatographs. The analysis result is then reported by the laboratory assistant to the manager of a process control system, so that he or she can input suitable modifications into the process control system if need be.

The manual working steps required of a laboratory assistant for carrying out the sample preparation may be very extensive. In order to help with this, automatic sample preparation systems have been developed for the sample preparation for chromatography, for example HPLC. Laborpraxis, Würzburg, 1990, 14, 11, 936, “Automatic sample preparation in HPLC”, Wolfgang Vogel, has disclosed such an automatic sample preparation system for HPLC. The system carries out fully automatically dilution series, system performance tests, multipoint calibrations, standard additions and precolumn derivatizations, which are normally carried out by a laboratory assistant. After the sample preparation, the samples are then examined by liquid chromatography.

Corresponding systems for automatic sample preparation have furthermore been disclosed by Journal of Chromatography A, 730 (1996), 39-46, “Automation of sample preparation as a preliminary stage in the high-performance liquid chromatographic determination of polyphenolic compounds in sherry wines”, D. A. Guillén et al., and in Journal of Automatic Chemistry, Vol. 17, No 1 (January-February 1995), pages 21-24, “A PC-controlled module system for automatic sample preparation and analysis”, Östen Einarsson.

A disadvantage common to such previously known automatic sample preparation systems is that they are suitable only for sample preparation for chromatography. Such automatic sample preparation systems are not hence flexibly usable for other analysis methods, but rather are only usable in a manner dedicated to chromatography. Another disadvantage is that samples to be analyzed have to be taken manually from the process and must be delivered to the sample preparation. A further disadvantage is that the analysis result is primarily only of an informative nature, and is not therefore used directly in the control of the process.

It is therefore an object of the invention to provide an improved process analysis system and an improved method and computer program product for controlling a process.

### SUMMARY OF THE INVENTION

The invention provides an analysis system which allows fully automatic integration of the sample analysis with upstream liquid sample preparation into a process control system. To this end, samples are automatically taken from the process by a suitable device. A sample which has been taken is processed by automatic sample preparation and then analyzed. The analysis result is then transmitted, for example via a field bus, to a process control system. The latter can then adjust the process accordingly. The present invention hence allows online conduct of sample preparation and analysis as an integral part of a process control system.

### DETAILED DESCRIPTION

The steps required in order to prepare the sample for the analysis are carried out by the automatic sample preparation. Depending on the analysis method which is employed, these may for example comprise the following steps:

filtration of the sample in order to prevent obstruction of lines, valves and columns,

dilution of the sample with one or more solvents, in which case the dilution may be carried out in one or more steps; the concentration of a sample is thereby brought into the measurement range of the analyzer being used; in particular, dilution series with different concentrations are possible, for example in order to carry out multipoint calibrations,

addition of an internal standard; the evaluation of the results is thereby facilitated, and a more accurate result is achieved in many cases;

cooling or thermal regulation of the sample in order to obtain a suitable temperature for the analysis; this is necessary in particular for temperature-sensitive substances as well as for substances which entail problems owing to their viscosity and, for example, which can be measured properly only when heated;

stripping of the sample with a gas, in order to remove unwanted volatile components;

stripping of the sample with a gas and analysis of the gas phase; volatile components, for example from waste water, can thereby be determined;

extraction of constituents by addition of suitable solvents;

precipitation of sample constituents, for example for purification or separation of other substances which are present;

derivatization, for example silylation of the sample, in order to convert the sample into a chemical form which is suitable for the analysis of the sample: in the case of reactive compounds, for example, without derivatization there is a risk that the sample may decompose on the chromatography column.

According to a preferred embodiment of the invention, a controllable bypass module is used for taking a sample from the process. The bypass module is connected to an automatic sample preparation system. This makes it possible to obtain a sample directly from the process via the bypass module, and to deliver it automatically to the sample preparation.

After the automatic sample preparation, the prepared sample is then delivered to an analyzer. The analysis result is then transmitted to a process control system, for example via a field bus.

According to a preferred embodiment of the invention, the automatic sample preparation apparatus is modularly constructed and comprises a plurality of modules. The modules are, for example, sample valves, burettes, dosing valves and the like, which are connected to one another via lines. The automatic sample preparation is hence carried out through appropriate operation of the individual modules by a control unit.

Preferably, the sampling unit for taking the sample from the process, as well as the analyzer, are modularly constructed and connected via such lines to the modules for the sample preparation. This provides a modularly constructed and integrated system for taking the samples, for the sample preparation and for the sample analysis. This modular construction has the advantage, in particular, that the automatic sample preparation can be adapted to different analyzers without great outlay.

According to a preferred embodiment of the invention, this modular construction is also reflected in the control program of the system. Driver software for each module is stored in the control unit of the system. The control program accesses this driver software in order to carry out the steps of the automatic sample preparation and analysis according to a working procedure predetermined by the user.

According to another preferred embodiment of the invention, the procedure of the control program is established by parameters which can be defined by the user. For example, the user may select available modules, and actions to be carried out by them, via a graphical user interface of a conventional personal computer (PC). In this way, procedure sequences for the sampling, the sample preparation and the sample analysis can be defined with the aid of the modules in a tabular form.

The parameters describing this procedure are then exported by the PC and transmitted to the control unit of the control system. There, these parameters establish the program procedure of the control program. The parameters hence determine the order in which the control program calls up individual driver programs, as well as the control parameters which the control program gives to the driver software in order to make a particular module perform a particular action.

A particular advantage in this case is that a computer expert is not needed for establishing the program procedure of the control program, since the program procedure can be entered intuitively via a graphical user interface by selecting modules and the actions to be carried out. In particular, a laboratory assistant or technician can hence use the graphical user interface to describe the steps previously carried out manually by him or her. This description is then used as the parameterization for the control program, so that the latter addresses the respectively required driver software in the necessary order.

According to a preferred embodiment of the invention, an automation component is used as the control unit, for example a Simatik S7 controller from the company Siemens AG. Such an automation component is designed for problem-free continuous use in an industrial environment, and is therefore not liable to “crash” like a conventional PC. A particular advantage in this case is that the PC, with the aid of which the user inputs the procedure, and the control unit can be disconnected from one another during operation of the system, i.e. the PC can be disconnected from the control unit after the parameters which establish the program procedure have been transmitted from the PC to the control unit. Operation of the control unit independently of the PC is therefore possible.

The analysis system according to the invention is particularly advantageous since, owing to its modular construction and the flexibility which can thereby be achieved, it can be used for a very wide variety of processes, in particular, for chemical, physical, biochemical, biotechnological or other industrial processes.

### BRIEF DESCRIPTION OF THE DRAWINGS

Preferred embodiments of the invention will be explained in more detail below with reference to the drawings, in which:

FIG. 1 shows a block diagram of a preferred embodiment of a control system according to the invention,

FIG. 2 shows a flow chart representing a preferred embodiment of the control method employing the system in FIG. 1,

FIG. 3 shows a preferred embodiment of a modularly constructed automatic sample preparation system with a bypass module and a sample analysis module,

FIG. 4 shows a perspective representation of representative combinations of the modules,

FIG. 5 shows a graphical user interface on a PC for establishing the program procedure,

FIG. 6 shows a block diagram of a preferred embodiment of the control system with an automation component.

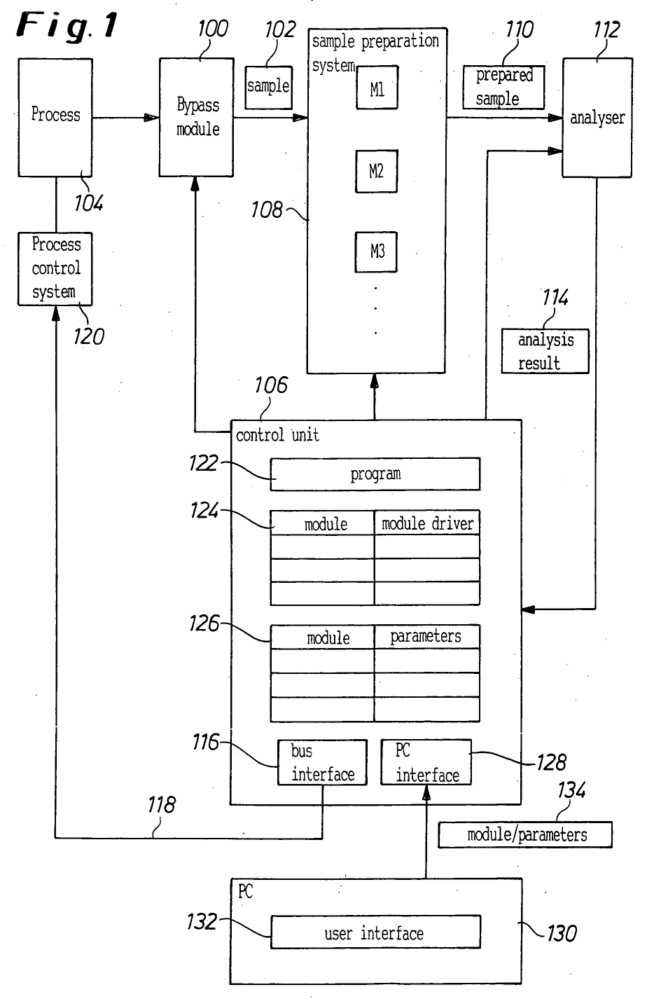

FIG. 1 shows a block diagram of an embodiment of an analysis system according to the invention. The analysis system has a bypass module 100 for taking a sample 102 from a process 104. The bypass module 100 is connected to a control unit 106, which can operate the bypass module 100 in order to take the sample 102 from the process 104.

The bypass module 100 is connected to a sample preparation system 108, so that the sample 102 goes from the bypass module 100 into the sample preparation system 108. The sample preparation system 108 contains various modules M1, M2, M3, . . . , a particular functionality being fulfilled by each of the modules.

The modules M1, M2, M3, . . . may be sample valves, burettes, dosing valves and the like. They are connected to one another via a line network. Through operation of the sample preparation system 108, i.e. individual modules of the sample preparation system, by the control unit 106, the sample 102 is hence subjected to automatic sample preparation. The resulting prepared sample 110 then goes from the sample preparation system 108 into the analyzer 112. The analyzer 112 is, for example, a gas or liquid chromatograph, a mass-spectrometry detector or analyzer for carrying out Raman spectroscopy or near-infrared spectroscopy. The analyzer 112 generates an analysis result 114 which is transmitted to the control unit 106, for example in the form of a data file.

Instead of a single analyzer 112, a plurality of such analyzers may also be connected to the sample preparation system 108 in a parallel circuit.

The control unit 106 has a bus interface 116, via which the control unit 106 is connected to a field bus 118. The latter may, for example, be a Profibus or industrial Ethernet. Coupling via conventional wiring (individual signals) or via serial interfaces is furthermore possible.

The control unit 106 outputs the analysis result 114, or part of it, via the bus interface 116 onto the field bus 118 in the form of a data stream, which has an automation component of the process control system 120 as its target addresses. The relevant automation component of the process control system 120 processes the analysis result as a control variable, for example by comparison with a setpoint value, in order to adjust the process 104 accordingly if need be.

As an alternative, the adjustment may also be carried out by transmitting the analysis result via the field bus 118 to a control panel, where it is displayed. The display of the analysis result may be combined with an acoustic or optical warning signal when the analysis result lies outside a setpoint range. Adjustment of the process may then be carried out if need be, for example through manual input by the user in order to modify a process parameter.

As another alternative, the control may also be carried out by using model-based automated process control, i.e. for example by using control in state space, a neural network or a hybrid neural network with rigorous model components.

The control unit 106 contains a program 122, which is used to control the program procedure of the sampling by operation of the bypass module 100, the sample preparation by operation of the sample preparation system 108 and the sample analysis by operation of the analyzer 112. In order to operate the bypass module 100, the modules M1, M2, M3, . . . , the sample preparation system 108 and the analyzer 112, the program 122 accesses corresponding driver programs 124 which are respectively assigned to the respective modules. The program procedure of the program 122 is established by parameters 126 which establish the chronological order of the operation of modules and the control parameters to be given to the respective driver program.

In order to input the parameters 126 into the control unit 106, the latter has a PC interface 128. The control unit 106 can be connected to a PC 130 by means of the PC interface 128. The PC 130 has a user interface 132, which is preferably designed as a graphical user interface.

A user inputs the parameters 126 via the user interface 132. After this input has been carried out, a corresponding file 134 is exported and transmitted from the PC 130 to the control unit 106. In this way, the control unit 106 receives the parameters 126 which establish the procedure of the program 122. After the file 134 has been transmitted from the PC 130 to the control unit 106, the link between the PC 130 and the control unit 106 can be disconnected. This has the advantage that unimpaired function of the control unit 106 is no longer dependent on the PC 130.

The user can also carry out selection of the analyzer 112 via the user interface 132, when there are a plurality of analyzers connected in parallel. The procedure of the program 122 for the conduct of the sample preparation necessary for the selected analyzer 112 is established at the same time by the selection of the analyzer 112.

Furthermore, it is also possible for the same sample preparation to be usable for different analyzers 112. In this case, an appropriate quantity of the sample is prepared and then apportioned to these analyzers. This apportioning of the prepared sample is likewise carried out under the control of the program 122.

Another variant is that a sample prepared for a particular type of analyzer requires further preparation steps in order to be used for another type of analyzer. In this case, a certain quantity of the sample prepared for the first type of analyzer may be extracted before carrying out further sample preparation steps with the remaining quantity of sample.

Via the program 122, it is hence possible for a sample to be prepared for a plurality of analyses to be carried out essentially simultaneously in the analyzers connected in parallel. It is likewise possible for the sample preparation to be carried out in several stages, the intermediate products being delivered, in the correct order, to corresponding types of analyzers.

The control system in FIG. 1 hence makes it possible to automate the manual taking of a sample from the process which was required in the prior art, and the sample preparation and analysis, and furthermore to feed the analysis result into a process control system as a control variable. On the one hand, this makes it possible to save significantly on personnel resources. On the other hand, owing to its modular construction, the control system can be adapted to different analysis tasks with very minor outlay in terms of both hardware and software.

The procedure can be defined intuitively via the graphical user interface, for example by a laboratory assistant or technician who can hence contribute his or her expertise to the automation of the procedure. Furthermore, the control system also allows improved process control since, on the one hand, the sampling is carried out in accurately predefined time intervals or at programmable times, the sample preparation and analysis are carried out fully automatically with consistent quality in a reproducible way, and the analysis result can be fed into the adjustment of the process as a control variable with no time delay.

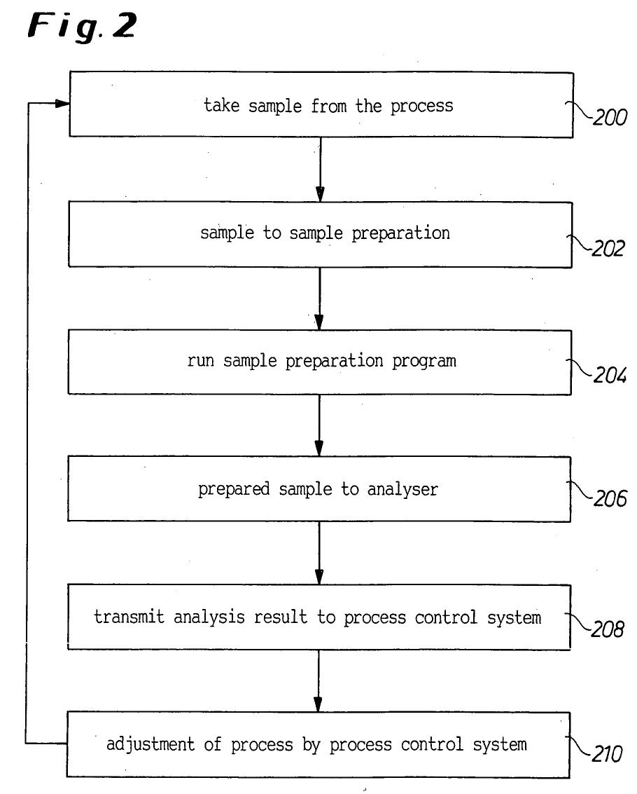

FIG. 2 illustrates this procedure once more. In step 200, a sample is taken from the process. This is done through operation of a sampling unit, for example a bypass module, by the control unit of the control system. In step 202, the sample which has been taken is then delivered to an automatic sample preparation system, for example via a liquid line. In step 204, the automatic sample preparation is carried out according to a predetermined program procedure. In step 206, the prepared sample is put into an analyzer, where it is analyzed.

If there are a plurality of analyzers, the prepared sample is divided up and put into two or more analyzers for an analysis running simultaneously in parallel. The consequent analysis result or results are then transmitted in parallel or sequentially to a process control system. This is done in step 208. In step 210, the process control system can make an adjustment to the process based on the analysis result, if need be.

Steps 200 to 210 are preferably performed cyclically within predetermined time intervals, or after the process control system has established that a particular condition has been satisfied and the process control system has used the field bus to send the control unit a corresponding request signal to obtain an analysis result.

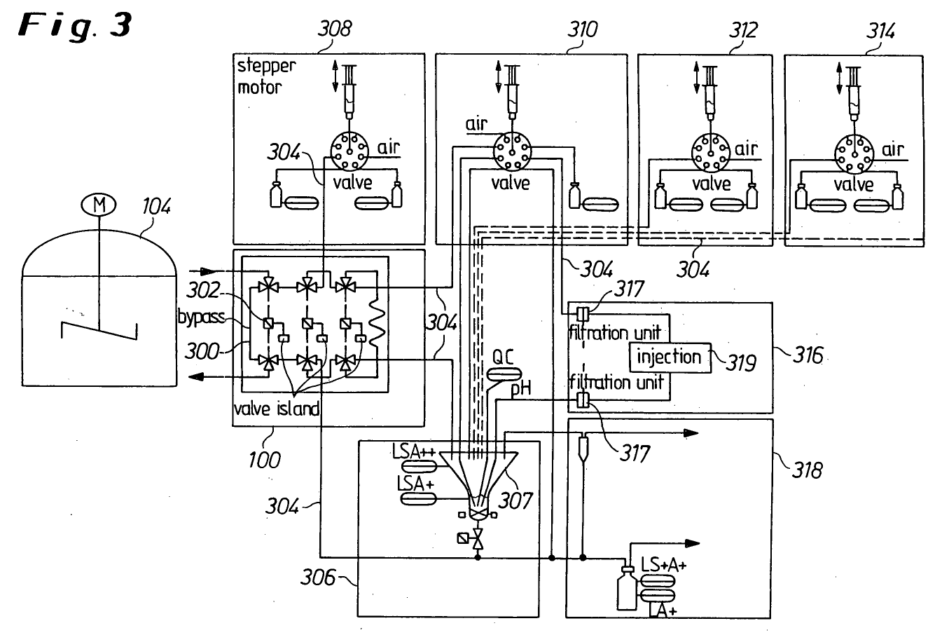

FIG. 3 shows an embodiment of the sampling, the automatic sample preparation and sample analysis of a control system according to the invention. Elements in FIG. 3 which correspond to elements in FIG. 1 are in this case denoted by the same references.

The bypass module 100 has a bypass 300 which, through various valves 302 which can be operated by the control unit, makes it possible to take a sample from the process 104. The bypass module 100 is connected via lines 304 to various modules of the sample preparation system. These include the sample preparation module 306, the calibration module 308, the syringe module 310 and other modules 312 and 314, the injection module 316 and the waste module 318. The said modules are connected to one another via lines 304 or can be connected to one another by appropriate valve settings. The various modules and valves can be operated by the control unit of the control system.

For example, the sample taken from the process 104 by the bypass module 100 goes directly, or via one of the other modules, into the sample preparation module 306 where further substances are added to the sample according to a predetermined procedure, for example in order to dilute the sample. To this end, a mixing vessel 307 is provided in the sample preparation module 306. Elements for regulating the sample to a suitable temperature may furthermore be provided in the sample preparation module 306. After the sample preparation has been completed, the prepared sample is taken from the sample preparation module 306 and injected into the analyzer via the injection module 316.

The injection module 316 has an injector 319, from which the prepared sample is injected directly into the analyzer. The prepared sample reaches the injector 319, for example, from the syringe module 310 or from the sample preparation module 306. Filtration units 317 are arranged in corresponding feed lines leading to the injector 319.

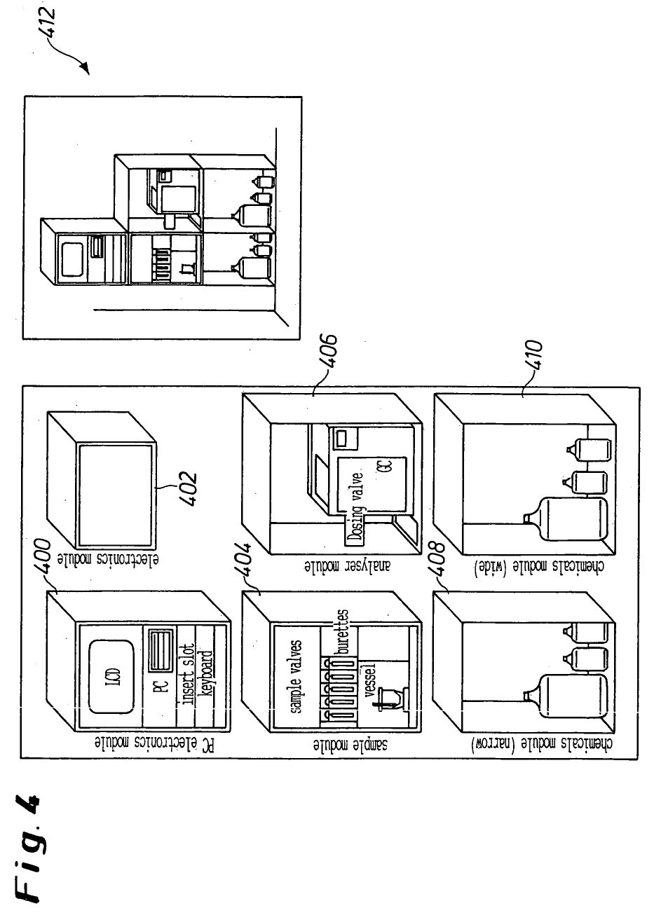

FIG. 4 shows an example of the various modules and their combination in a perspective view. For example, the following predetermined modules are available for the construction of the control system: PC electronics module 400 with an LCD display, a PC slot and a keyboard, electronics module 402 for holding the control unit, sample module 404 for fulfilling various functionalities, analyzer module 406 with an analyzer, for example a gas chromatograph, into which a prepared sample can be introduced via a dosing valve, chemicals module 408 and 410 of different sizes. The chemicals modules 408 and 410 can be used to hold various solvents, an internal standard, calibration solutions, extraction agents or derivatization reagents.

These modules may, for example, be interconnected to form the combination 412. A sample preparation system can hence be assembled flexibly according to the sample preparation required for the analysis.

It is furthermore advantageous that the modules can be planned and manufactured individually. Furthermore, a plurality of sample modules may be connected to a single analyzer, and different analyzers may also be connected to a single sample module.

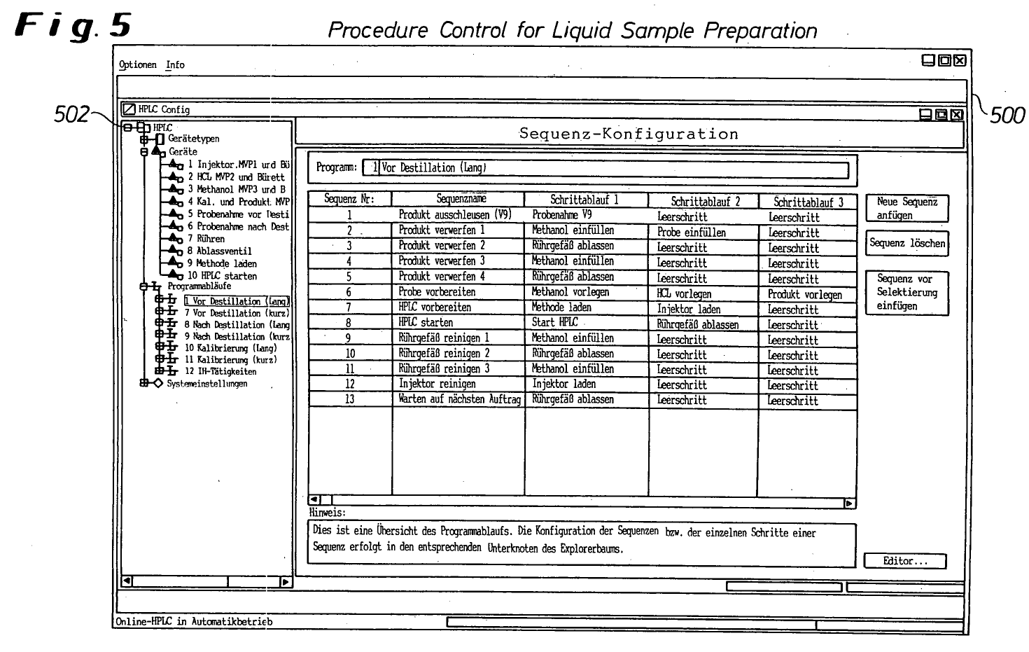

FIG. 5 shows a window 500 of a graphical user interface (cf. the user interface 132 in FIG. 1). The window 500 contains the representation of an explorer tree 502 in which the available modules are listed, i.e. the “devices” of the automatic sample preparation system. The explorer tree 502 furthermore shows the program procedures which can be carried out with the aid of these devices.

A program procedure is input by a user in a tabular form. To this end, the program procedure is subdivided into sequences, to which a sequence number is respectively assigned. Each sequence is furthermore given a sequence name. A sequence consists of, for example, three steps. A user-defined action is carried out by one of the devices in each step. The user can hence intuitively establish the program procedure for the sample preparation by selecting devices and inputting corresponding parameters.

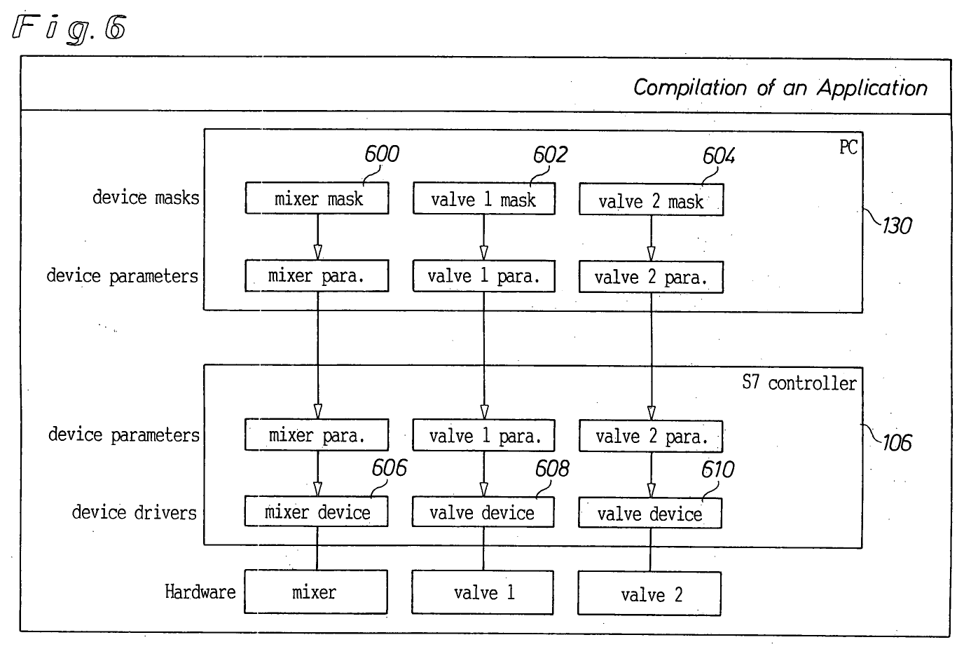

According to the embodiment in FIG. 6, this is done by calling up a separate mask 600, 602 and 604 for each device selected by the user, for example “mixer”, “valve 1” and “valve 2”, respectively. The user inputs the specific device parameters via such a mask.

The device parameters are then transmitted from the PC 130 to the control unit 106, which is for example a Simatik S7 controller from the company Siemens. During the running of the program in the control unit 106, these parameters are then given to the corresponding device drivers 606, 608, 610. The corresponding hardware components are operated by means of this.

The software development is preferably carried out on the basis of function types. Function types form the basis for the compilation of procedures, i.e. they contain information and parameters pertaining to a particular functionality. The function types are used as a library and are programmed for the control unit. The function parameters are then mapped in the PC.

From the library of function types, a type is selected and specially parameterized. This provides the description of a device, which is given its own name and can be included in the procedures. The relevant device name appears in the explorer tree of the user interface (cf. Explorer tree 502 in FIG. 5).

Procedures can be established on the basis of the devices defined in this way by selecting the devices in a particular order. A procedure consists of a number of sequences, which are carried out in succession. Each sequence defines a plurality of actions. Up to three actions may preferably be defined in a sequence, and these are run in parallel. In this case, an action consists of a defined device which is started in a sequence within a procedure. A cycle is defined by the order of the procedures which is established in this way by the user.

On the basis of function types, i.e. an abstract description of device classes, device descriptions can hence be compiled efficiently for the specific parameters of a sample preparation.

### List of References

bypass module 100

sample 102

process 104

control unit 106

sample preparation system 108

prepared sample 110

analyzer 112

analysis result 114

bus interface 116

field bus 118

process control system 120

program 122

driver programs 124

parameters 126

PC interface 128

PC 130

user interface 132

file 134

bypass 300

valve 302

lines 304

sample preparation module 306

mixing vessel 307

calibration module 308

syringe module 310

module 312

module 314

injection module 316

filtration unit 317

waste module 318

injector 319

PC electronics module 400

electronics module 402

sample module 404

analyzer module 406

chemicals module 408

chemicals module 410

combination 412

window 500

explorer tree 502

mask 600

mask 602

mask 604

device driver 606

device driver 608

device driver 610

We claim:

1. Analysis system for a process, having:
a sampling unit,
a sample preparation system,
an analyzer, and
a control unit
wherein said sampling unit is adapted to take a sample from a sample source and provide said sample to said sample preparation system, said sample preparation system is adapted to prepare said sample for analysis and provide the so prepared sample to said analyzer, and said analyzer is adapted to analyze said prepared sample and communicate the results of said analysis to said control unit, and said control unit is adapted to provide a signal to a process control unit in accordance with the results of said analysis.

2. Analysis system according to claim 1, wherein said sampling unit is a controllable bypass for taking a liquid sample.

3. Analysis system according to claim 1 or 2, wherein said sample preparation system is a modular system comprising a plurality of modules.

4. Analysis system according to claim 3, wherein said control unit is adapted to communicate with said sample preparation system and comprises a control program and driver programs for the modules of the sample preparationsystem.

5. Analysis system according to claim 4, wherein said control program comprises a program procedure which is determinable in accordance with data imported from a computer.

6. Analysis system according to claim 5, wherein said computer comprises a representation for each module of the sample preparationsystem, and a user interface through which representations of the modules and the actions to be carried out by the selected modules are selectable to assemble an analysis sequence, and the computer is adapted to export data defining said analysis sequence to the control program.

7. Analysis system according to claim 1, wherein said analyzer comprises a chromatograph or a combination of a chromatograph and a mass-spectrometry detector (GC-MS or HPLC-MS).

8. Analysis system according to claim 1, wherein said control unit comprises a bus interface and said analyzer communicates with said process control system through said interface with a bus system of the process control system.

9. Method for controlling a process, comprising the steps of:
taking a sample from the process by operation of a sampling unit, which is coupled to an automatic sample preparation system,
delivering the sample to the automatic sample preparation system,
carrying out an automatic sample preparation under the the control of a control program,
delivering the so prepared sample to an analysis unit, and analyzing said sample to produce an analysis result, and
transmitting said analysis result to a process control system which adjusts said process in accordance with said analysis result.

10. Method according to claim 9, wherein the automatic sample preparation system is modularly constructed, comprises a plurality of modules, said modules comprising driver software, and the control program is adapted to access the driver software of the modules in accordance with parameters which are predeterminable by a user.

11. Method according to claim 10, comprising transmitting parameters from a computer to a control unit of the automatic sample preparation system for parameterization of the control program before the start of the control program.

12. Method according to claim 11, comprising selecting modules and actions to be carried out by the modules by a user via a user interface of the computer in for transmission to the control unit.

13. Digital storage media having stored thereon a computer program product for a control unit of an analysis system for a process, for carrying out the following steps:
operation of a sampling unit for taking a sample from the process,
operation of a sample preparation system for automatically carrying out a sample preparation of the sample which has been taken,
operation of an analyzer for analysis of the prepared sample,
outputting an analysis result onto a bus system of a process control system, for adjustment of the process by the process control system in accordance with the analysis result.

14. Digital storage media according to claim 13, wherein the computer program accesses modules of the sample preparation system for the automatic sample preparation through driver program modules.

15. Digital storage media according to claim 14, on which the program procedure for the carrying out the automatic sample preparation is established by data imported from a computer.
